(19) United States
(12) Patent Application Publication
(10) Pub. No.: US 2022/0405779 A1
(43) Pub. Date: Dec. 22, 2022

(54) PERSONAL tile graphic and/or tile color SYSTEMS AND METHODS

(71) Applicant: Kent L. Ross, SR., Clayton, OH (US)

(72) Inventor: Kent L. Ross, SR., Clayton, OH (US)

(21) Appl. No.: 17/355,108

(22) Filed: Jun. 22, 2021

(51) Int. Cl. G06Q 30/02; G06Q 30/06; G06F 16/23

(52) U.S. Cl. CPC G06Q 30/0203; G06Q 30/0621; G06F 16/23

(57) ABSTRACT

A tile graphic and/or tile color system for generating at least one customized tile graphic and/or tile color to at least one user, the tile graphic and/or tile color system includes an input module configured to input a plurality of attributes, an analysis module configured to analyze the plurality of attributes by using one or more mathematical algorithms to identify one or more color or graphic for a tile graphic and/or tile color corresponding to each of the plurality of the attributes, a categorization module configured to determine at least one category, and a display module configured to display the customized tile graphic and/or tile color to the at least one user.

### BACKGROUND

### 1. Field of Invention

The invention relates to the field of tile products. More particularly, the invention relates to a customized tile graphic and/or tile color system and method for personalized tile production.

Embodiments of the present invention generally relate to a system and method to generate a customized tile graphic and/or tile color for a user and particularly to a system and method for automatically generating and generating a customized tile graphic and/or tile color to complement existing graphic and/or color of the user and/or an inventory associated with the vendor.

### 2. Description of Related Art

Wall and floor tile have thus far been limited to colors and images created by the manufacturer. These manufacturers provide limited choices but are designed to attract the widest percentage of the market. Appropriate color selection form a tile graphic and/or tile color in various industries such as, but not limited to, home commercial, and retail products and environments. The appropriate selection and other personal preferences of a user are thus limited to what the manufacturer provides. However, it is important to the user to select harmonious colors and graphics and combinations which may meet their desire or best work in the particular environment where the tiles are to be installed.

There is thus a need for a system and method for providing customized tile graphic and/or tile color uniquely compatible with the existing environment of a user in which formulas and automated expertise may be applied to create a customized tile graphic and/or tile color.

### SUMMARY

Embodiments in accordance with the present invention provide a tile graphic and/or tile color system for generating at least one customized tile graphic and/or tile color to at least one user and/or providing a user provided graphic and/or color in which to manipulate and enable application thereof to the tile. The tile graphic and/or tile color system includes a user input module configured to receive a plurality of attributes comprising an environment color or graphic for one or more tangible objects, or a combination thereof, associated with the user. The tile graphic and/or tile color system further includes one or more databases configured to store the plurality of input attributes associated with the user. The tile graphic and/or tile color system further includes an analysis module configured to analyze the plurality of input attributes by using one or more mathematical algorithms to identify one or more colors or graphics from a tile graphic and/or tile color corresponding to each of the plurality of the input attributes, wherein the identification of one or more colors or graphics comprising: comparing the color or graphic of the plurality of input attributes with the tile graphic and/or tile color stored in the one or more databases; selecting the one or more color or graphic from the one or more databases based on the comparison, wherein the one or more databases are updated when a new color or graphic is identified. The tile graphic and/or tile color system further includes a categorization module configured to determine at least one category for the user based on the identification of the one or more color or graphic corresponding to each of the plurality of the input attributes. The tile graphic and/or tile color system further includes a generation module configured to provide one or more generated customized tile graphic and/or tile color to the user based on the determined category and generating a printed tile with the generated color or graphic. The tile graphic and/or tile color system further includes a display module configured to display the customized tile graphic and/or tile color to the user. The tile graphic and/or tile color system further includes a production module for forming a particular tile configuration and that the print tile graphic and/or tile color can be applied on the formed tile pre or post forming.

Embodiments in accordance with the present invention further provide a computer-implemented method for generating at least one customized tile graphic and/or tile color to user. The method includes inputting a plurality of attributes comprising a plurality of colors or graphics for one or more tangible objects, or a combination thereof associated with an install environment of the user; storing the plurality of input attributes associated with the user; analyzing the plurality of attributes by using one or more mathematical algorithms to identify one or more colors from a tile graphic and/or tile color corresponding to each of the plurality of the attributes, wherein the identification of one or more color or graphic comprising comparing the color or graphic of the plurality of input attributes with the tile graphic and/or tile color stored in the one or more databases; selecting the one or more color or graphic from the one or more databases based on the comparison, wherein the one or more databases are updated when a new color is identified; determining at least one category for the install environment of the user based on the identification of the one or more input color or graphic; providing one or more generated data image for the at least one customized tile graphic and/or tile color to the user based on the determined category; and displaying the customized tile graphic and/or tile color to the user.

Embodiments of the present invention may provide a number of advantages depending on its particular configuration. First, embodiments of the present application provide a system and a method for evolution of a digitized library using artificial intelligence. Next, embodiments of the present application provide a customized tile graphic and/or tile color harmonious to a user based on input environment attributes associated with the user.

Next, embodiments of the present application may generate a tile graphic and/or tile color data to the user based on input attributes of the user environment. The tile graphic and/or tile color may include a color or graphic to determine a best buying choice for the user. Next, embodiments of the present application may enable users to use the color or graphic system.

Embodiments of the present application may enable vendors to reduce the types of inventory based on the system of the instant invention and reduce costs and waste. The embodiments of the present application may improve a vendor customer service by providing ability to their customers to buy from a collection of substrates such as PVC or glass.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a block diagram depicting a tile graphic and/or tile color system, according to an embodiment of the present invention;

FIG. 2 illustrates a functional block diagram of a tile graphic and/or tile color platform, according to an embodiment of the present invention;

FIG. 3 depicts a flowchart of a method for creating a digital tile graphic and/or tile color library, according to an embodiment of the present invention;

FIG. 4 depicts a flowchart of a method for generating tile graphic and/or tile color data to a user, according to an embodiment of the present invention; and

FIG. 5 depicts a flowchart of a method for creating a vendor's digital library of objects and then providing recommendations to a consumer, according to an embodiment of the present invention.

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modification, equivalents and alternatives falling within the spirit and scope of embodiments of the present invention as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The terms “RGB”, and variations thereof, as used herein, are used interchangeably and include any type of an additive color system where primary colors are, red, green, and blue.

The terms “CMY”, “CMYK”, and variations thereof, as used herein, are used interchangeably and include any type of a subtractive color model where cyan, magenta, yellow, and black inks can be mixed to produce any color.

The terms “hue, saturation, value”, “HSV”, and variations thereof, as used herein, are used interchangeably is an alternative representation of the RGB color model. This color model describes colors such as, but not limited to, tint or hue in terms of their shades for example, saturation or amount of gray, and their brightness value.

Embodiments in accordance with the present invention provide a tile graphic and/or tile color system for generating for customized tile graphic and/or tile color to users based on their environmental attributes, which can include home, commercial or retail. Further, the embodiments in accordance with the present invention provide a tile graphic and/or tile color system for creating a global digital tile graphic and/or tile color library.

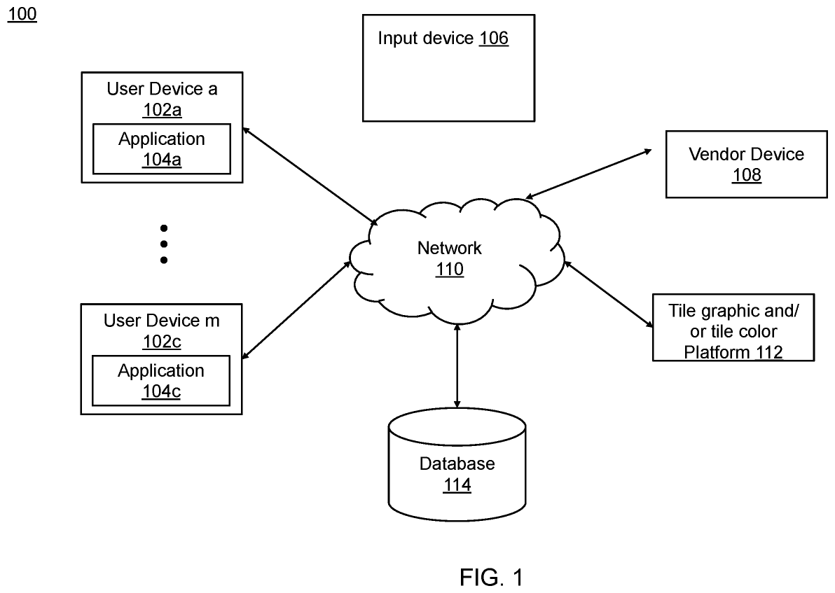

FIG. 1 illustrates a block diagram depicting a tile graphic and/or tile color system 100 (hereinafter referred to as “a tile graphic and/or tile color system 100”), according to an embodiment of the present invention. The tile graphic and/or tile color system 100 may generate for a tile graphic and/or tile color to a user based on attributes associated with the user's preference or environment.

The tile graphic and/or tile color system 100 may include a plurality of user devices 102a-c (hereinafter referred to as “a user device 102”). The user device 102 may be, but is not limited to, a mobile device, a smart phone, a tablet computer, a portable computer, a laptop computer, and so forth. Embodiments are intended to include or otherwise cover any type of a user device 102, including known, related art, and/or later developed technologies. Each of the user device 102 may comprises an input device, i.e., mouse, keyboard, microphone, camera, scanner (not shown) in order to collect data from the user.

The user may be a consumer who desires for a recommendation for a customize tile graphic and/or tile color. Further, the user device 102 may include one or more software applications such as, but is not restricted to, an e-commerce application, a navigation application, a camera application, a media player application, a social networking application, and the like. In an embodiment of the present invention, the user device 102 may include a proprietary tile graphic and/or tile color application 104a-c (hereinafter referred to as “a tile graphic and/or tile color application 104”). A user may access the tile graphic and/or tile color application 104 by using log-in credentials, in an embodiment of the present invention. The user may first register with a service provider of the tile graphic and/or tile color application 104, and then a user profile is created. In an embodiment of the present invention, the tile graphic and/or tile color application 104 may be a software application that is registered with a tile graphic and/or tile color platform 112.

Further, the tile graphic and/or tile color system 100 may include an input device 106. In an embodiment of the present invention, the input device 106 may be any device that is capable of inputting any tile graphic and/or tile color data from user from a number of resources for generating one or more tile graphic and/or tile color image data. The input device 106 may provide by its data via a camera receiving an image of an area of the user environment. In an embodiment of the present invention, the input device 106 may be any software application installed in a user device 102, and/or a vendor device 108 that is available for sending/receiving tile graphic and/or tile color data. In another embodiment of the present invention, the input device 106 may be, but not limited to, a mobile device, a smart phone, a tablet computer, a portable computer, a laptop computer, and so forth. Embodiments are intended to include or otherwise cover any type of input device 106, including known, related art, and/or later developed technologies, which may be beneficial to determine tile graphic and/or tile color. The resources may include, but not limited to, printable media, digital formats, software applications, advertisings, marketing, swatches and/or color palettes from various industries, images, and so forth. The input device 106 may further be configured to input attributes of tangible objects associated with a user, in an embodiment of the present invention. The attributes of the user may include physical attributes such as, but not limited to, environment location, and particular room within the environment, etc.), and so forth, in an embodiment of the present invention. Examples of the tangible objects may include, but not limited to, surrounding fixtures, such as surrounding wall color, vanity, bar, residential, commercial or retail setting, and so forth.

The tile graphic and/or tile color system 100 may further include a vendor device 108 that may use the tile graphic and/or tile color application 104 to create its inventory of objects, in an embodiment of the present invention. In another embodiment of the present invention, the vendor device 108 may use the tile graphic and/or tile color application 104 to provide recommendations for customized color palettes to the consumers. The vendor device 108 may work in conjunction with the input device 106 to input attributes and/or tangible objects, in an embodiment of the present invention. In another embodiment of the present invention, the vendor device 108 may include an input device 106 to input the attributes and/or tangible objects.

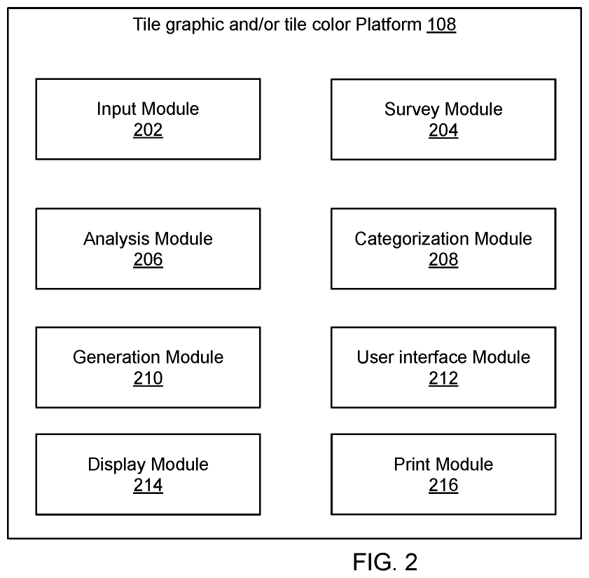

Further, the tile graphic and/or tile color application 104 may be managed by a tile graphic and/or tile color platform 112, in an embodiment of the present invention. The working of the tile graphic and/or tile color platform 112 is described in detail in conjunction with FIG. 2. In an embodiment of the present invention, the tile graphic and/or tile color platform 112 may be a software application stored in a server (not shown). In another embodiment of the present invention, the tile graphic and/or tile color platform 112 may be implemented as a hardware, a firmware, a software, or a combination thereof managed by a third-party service provider.

The tile graphic and/or tile color system 100 may further comprises a database 114, in an embodiment of the present invention. The database 114 may store the data associated with the devices such as, but not limited to, the user device 102, the input device 106, the vendor device 108, the tile graphic and/or tile color platform 112, and so forth. However, only one database is shown in the FIG. 1, it is to be contemplated that more than one database may also be used to store the data.

The communication between the user device 102, the input device 106, the vendor device 108, the tile graphic and/or tile color platform 112, the database 114, and so forth may be done through a communication network 110. The communication network 110 may include a data network such as, but not restricted to, the Internet, Local Area Network (LAN), Wide Area Network (WAN), Metropolitan Area Network (MAN), etc. In certain embodiments of the present invention, the communication network 110 may include a wireless network, such as, but not restricted to, a cellular network and may employ various technologies including Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS) etc. In some embodiments of the present invention, the communication network 110 may include or otherwise cover networks or sub-networks, each of which may include, for example, a wired or wireless data pathway. The communication network 110 may include a circuit-switched voice network, a packet-switched data network, or any other network capable for carrying electronic communications. For example, the communication network 110 may include networks based on the Internet Protocol (IP) or Asynchronous Transfer Mode (ATM), and may support voice usage, for example, VoIP, Voice-over-ATM, or other comparable protocols used for voice data communications.

Examples of the communication network 110 may further include, but are not limited to, a Personal Area Network (PAN), a Storage Area Network (SAN), a Home Area Network (HAN), a Campus Area Network (CAN), a Local Area Network (LAN), a Wide Area Network (WAN), a Metropolitan Area Network (MAN), a Virtual Private Network (VPN), an Enterprise Private Network (EPN), the Internet, a Global Area Network (GAN), and so forth. Embodiments are intended to include or otherwise cover any type of communication network, including known, related art, and/or later developed technologies to connect the components of the health care system 100 with each other.

FIG. 2 illustrates a functional block diagram of the tile graphic and/or tile color platform 112, according to an embodiment of the present invention. The tile graphic and/or tile color platform 112 may include, but not limited to, an input module 202, a survey module 204, an analysis module 206, a categorization module 208, a generation module 210, a user interface module 212, a display module 214, and a print module 216.

The input module 202 may be configured to input a plurality of attributes from various resources. As discussed above, the resources may include, but not limited to, printable media books, digital formats, presentations, software applications and websites, advertisings, marketing, swatches and/or color palettes from various industries, images, and so forth. In another embodiment of the present invention, the input module 202 may further be configured to input attributes of a user. The attributes of the user may include physical attributes such as, but not limited to, surrounding fixtures, such as surrounding wall color, vanity, bar, residential, commercial or retail setting, and so forth. The input module 202 may be configured to input multiple parts of the environment. In yet another embodiment of the present invention, the input module 202 may be configured to input attributes of tangible objects associated with the user, which may include, but not limited to those previously described. The input data associated with the user may be stored in a database, such as the database 114 for further processing.

The input module 202 may further be configured to input a plurality of tangible objects associated with a vendor. The tangible objects may include, but not limited to, surrounding fixtures, such as surrounding wall color, vanity, bar, residential, commercial or retail setting, and so forth. The input data of the tangible objects may be stored in a database, such as the database 114 to manage the inventory associated with the vendor.

The survey module 204 may be configured to conduct a survey from the user, in an embodiment of the present invention. The survey may include a plurality of questionnaire associated with the user, which may include, but not limited to, a favorite color, a favorite season, a color preference in lipsticks, a color of eyes, preferred clothes, accessories, and so forth. The surveyed data may then be stored in a database, such as, but not limited to, the database 114.

The analysis module 206 may be configured to analyze the input data, in an embodiment of the present invention. The analysis module 206 may be configured to analyze the input colors and measure values of each of the input colors in terms of, but not limited to, RGB, CMYK, HSV, and so forth. The analysis module 206 may be configured to measure values of colors based on, but not limited to, Red (RGB) %, Green (RGB) %, Blue (RGB) %, Hue (HSL/HSV) degree, Saturation (HSL) %, Light (HSL) %, Saturation (HSV) %, Value (HSV) %, Chroma, brightness, reflection, absorption, diffusion, and so forth. Further, the analysis module 206 may be configured to generate a data file that comprises measured values of each of the input colors.

Furthermore, the analysis module 206 may be configured to assign a hexadecimal value to each of the input colors according to a hex color code scheme. The hex color code is a way of representing a color using hexadecimal values. The hex color code is a hex triplet that represents three separate values of the component colors. The hex color code starts with a hash sign (#) and is followed by six hex values or three hex value pairs (for example, #AEF645). As such, the hex value pairs refer to the RGB color space. The hex color code may describe the composition of a particular color in a color space, such as RGB, CMYK and HSV. Embodiments of the present invention are intended to include or otherwise cover any other such color scheme, including known, related art, and/or later developed technologies that may be beneficial to assign a value to a corresponding color.

In an embodiment of the present invention, the analysis module 206 may be configured to assign a label to each of the input colors. The label may be assigned in a format, for example, “Name, Index, Label 1 tile color”, “Name, Index, Label 1 tile graphic” and so forth.

The analysis module 206 may further be configured to create a value scale table for each of the input colors within hue. The value scale table may be created based on the measured values of the RGB, CMYK, etc., hexadecimal value, and an assigned label. In an exemplary scenario, a first value scale table is created for shades of red, a second value scale table is created for a shade of blue, and so forth. These value scale tables are then stored in a database, such as the database 114 and, therefore, a digital library of colors is created. In an embodiment of the present invention, while creating the digital color library, some of the spaces in the value scale tables are left unfilled for the purpose of adding new colors in future related to a same shade and/or tone.

Further, the analysis module 206 may be configured to analyze the input attributes of the user in order to identify environmental aspects of the user. These aspects may include paint color, construction material, fixtures in the environment, location, and so forth.

Further, by using mathematical algorithms, the analysis module 206 may further be configured to identify colors based on each of the attributes of the user. The mathematical algorithms may include, but not limited to, fuzzy logic, artificial intelligence, and so forth. Embodiments of the present invention are intended to include or otherwise cover any mathematical algorithm, including known, related art, and/or later developed technologies, which may be beneficial to identify colors based on each of the attributes associated with the user.

The analysis module 206 may be configured to identify the colors by comparing the input color of the attributes with the pre-stored color palettes in the database, such as the database 114. Based on the comparison, colors from the color palettes matching the input colors and graphic of the attributes may be selected by the analysis module 206. In an embodiment of the present invention, when a new color is identified by the analysis module 206 based on the measured values of the RGB, CMYK, and so forth, then a new label is assigned to the new color and is then added to the unfilled spaces within the value scale table associated with the identified color. The value scale table is then updated and stored in the database, such as the database 114.

The analysis module 206 may further be configured to analyze colors from images that are provided by the user. Based on the color analysis, the analysis module 206 may then identify colors in the images using the pre-stored color palettes and graphics within the database, such as the database 114.

The categorization module 208 may be configured to determine a category for the user. In an embodiment of the present invention, the categorization module 208 may determine a category based on the identified colors corresponding to the input attributes of the user. The category may include, for example, but not limited to, a commercial, residential or retail and locations therein or a combination thereof. The categorization module 208 may first be configured to determine a color or graphic for the user. The color or graphic may be categorized to the particular environment. The color and or graphic may tend to be associated with objects that are associated with the environment be it indoor or outdoor, for example, but not limited to, sky, night, rock, south, west, east, coastal, north and so forth, and may therefore, be categorized accordingly.

The categorization module 208 may further be configured to determine a category for an input object at a vendor's store, in an embodiment of the present invention. The categorization module 208 may designate a color and/or graphic to the input objects while managing the inventory of the vendor when new objects are input and stored in the inventory. The object may be of any brand for application of the color or graphic.

Further, based on the above environment and categories, the categorization module 208 may be configured to categorize the input colors and graphics and store the categorized colors and graphics in the database, such as the database 114.

The generation module 210 may be configured to generate to the user. The generation module 210 may generation a customized tile graphic and/or tile color to the user based on the determined category, in an embodiment of the present invention. In an exemplary scenario, if a first user belongs to an office environment, then the generation module 210 may generation a customized tile graphic and/or tile color that may include shades of grey, black, rust, and so forth. On the contrary, if a second user belongs to a residential environment for application to a kitchen, then the generation module 210 may generation a customized tile graphic and/or tile color that may include shades of white, soft white, raspberry, navy, aqua, and so forth.

In another embodiment of the present invention, the generation module 210 may further be configured to generate one or more web addresses for one or more shopping websites from where the user may purchase desired substrates for application of the color and/or graphic selected, and so forth based on the determined category or a palette of colors or graphic recommended to the user.

In yet another embodiment of the present invention, the generation module 210 may be configured to provide generate to a user about an object from the user's inventory. In an exemplary scenario, a user desires a shiplap or subway tile background, then the generation module 210 may generate about a suitable substrates stored in the inventory of the user based on the user's determined category. In another exemplary scenario, the generation module 210 may generate to a vendor to display a particular PVC substrate or glass substrate to a customer.

The recommendation module 210 may further be configured to provide images that are stored in the database, such as the database 114 based on the palettes of colors and graphics generated to the user.

The generation module 210 may further be configured to provide inspiring messages to the user to let the user know which color or graphic may work best. In an exemplary scenario, the recommendation module 210 may provide a message “Bright White is Trending!” when a user picks a subway tile from the user's inventory, or “Sprinkle a message into the tile like “no place like home” or “continue shopping and let this one go” when the user is shopping at a vendor's store.

The user interface module 212 may be configured to provide a user interface of the color application 104 on the user device 102 and/or the vendor device 108. The user and/or the vendor may install the color graphic application 104 on their respective user device 102 and/or the vendor device 108. The user and/or the vendor may create an account on the color graphic application 104 that is managed by the tile graphic and/or tile color platform 112 in order to receive the generated data about customized color palettes. and/or graphics In an embodiment of the present invention, the user interface module 212 may function in conjunction with the input module 202, the survey module 204, in order to receive data from the user and/or the vendor. The data may include, but not limited to, a name, an age, a contact information, an email address, color preferences, and so forth.

Further, the user interface module 212 may be configured to display a log-in user interface of the color application 104 on the user device 102 and/or the vendor device 108. The user and/or vendor may log-in the color application 104 by using log-in credentials, such as, but not limited to, a sign-in ID and a password, and/or a biometric, for example, a fingerprint, a face recognition, etc. Embodiments of the present invention are intended to include or otherwise cover any type of data, including known, related art, and/or later developed technologies to securely log-in into the color application 104.

The display module 214 may be configured to display the customized tile graphic and/or tile color to the user. The display module 214 may function in conjunction with the user interface module 212 in order to display the customized tile graphic and/or tile color on the user device 102 and/or the vendor device 108. In an embodiment of the present invention, the display module 214 may be configured to display the customized tile graphic and/or tile color in, but not limited to, repeating form, a collage, or other. The display module 214 may be configured to display the tile graphic and/or tile color in a template as selected by the user, in an embodiment of the present invention. In another embodiment of the present invention, the user interface module 212 may be configured to display an image of an object generated by the generation module 210, which is stored in the user's and/or vendor's inventory. In yet another embodiment of the present invention, the display module 214 may be configured to display the inspiring messages generated by the generation module 210.

The print module 216 may be configured to print the generated customized color or graphic for the user onto the selected substrate. The production module can 218 can receive the printed substrate post or preprinting and perform necessary configuration forming steps thereon, such as routing edge of the material of the substrate prior or post the printing step. The printed customized tile graphic and/or tile color may then be provided to the user for perfect color matching and purchasing of desired objects based on the determined category.

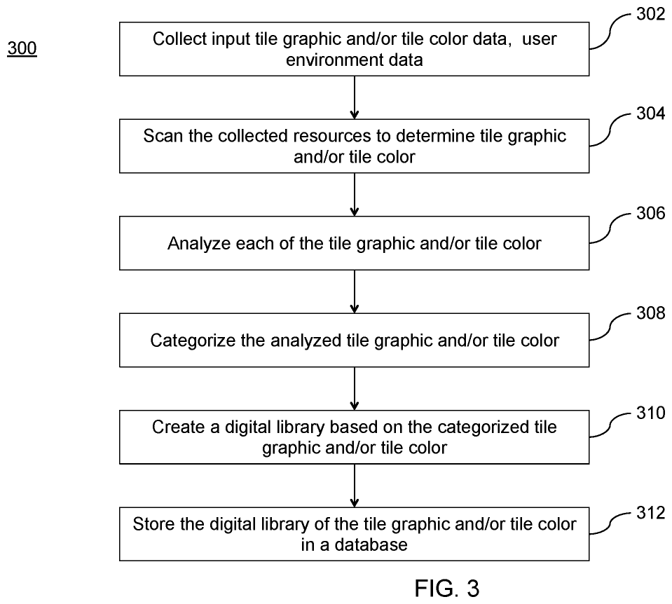

FIG. 3 depicts a flowchart of a method 300 for creating a digital color library, according to an embodiment of the present invention. At step 302, the tile graphic and/or tile color system 100 may collect resources for inputting tile color and tile graphics. As discussed above, the resources, books, digital formats, software applications and websites, advertisings, marketing, swatches and/or color palettes from various industries, images are envisioned.

At step 304, the tile graphic and/or tile color system 100 may input the collected resources to determine color or graphic of each. In an embodiment of the present invention, the scanning may be done by using an input device, such as the input device 106, the user device 102, the vendor device 108, and so forth.

At step 306, the tile graphic and/or tile color system 100 may analyze the input colors. The tile graphic and/or tile color system 100 may analyze the input colors and measure values of each of the input colors in terms of, but not limited to, RGB, CMYK, HSV, and so forth. Further, the tile graphic and/or tile color system 100 may generate a data file that comprises quantified values of each of the input color and graphic. The tile graphic and/or tile color system 100 may quantify values of color or graphic, which may include, but not limited to, Red (RGB) %, Green (RGB) %, Blue (RGB) %, Hue (HSL/HSV) degree, Saturation (HSL) %, Light (HSL) %, Saturation (HSV) %, Value (HSV) %, Chroma, brightness, reflection, absorption, diffusion, and so forth.

In an embodiment of the present invention, the tile graphic and/or tile color system 100 may be configured to digitally formulate color and/or graphic by combining multiple digital color or graphics (additive or subtractive). The outcome of the mixing that is a third color or graphic may then be stored in a database, such as the database 114. In an embodiment of the present invention, the tile graphic and/or tile color system 100 may calculate a hexadecimal value for the third color or graphic based on hexadecimal values.

Furthermore, the tile graphic and/or tile color system 100 may assign a hexadecimal value to each of the input color and graphic according to a hex color code scheme. The hex color or graphic code is a way of representing a color or graphic using hexadecimal values. The tile graphic and/or tile color system 100 may assign a label to each of the input color or graphic. The label may be assigned in a format, for example, “Name, Index, Label 1 physical set of tile graphic or tile color” “Name, Index, Label 1 physical set of environmental attributes”, and so forth. Also, the tile graphic and/or tile color system 100 may create a value scale table for each of the input color or graphic. The value scale tables may be created based on the measured values of the RGB, CMYK, etc., hexadecimal value, and an assigned label. The above defined steps are performed to digitalize the colors.

At step 308, the tile graphic and/or tile color system 100 may categorize the analyzed colors. In an embodiment of the present invention, the tile graphic and/or tile color system 100 may categorize the value scale tables of colors based on seasons. The tile graphic and/or tile color system 100 may categorize each input data based on factors such as, but not limited to, an a user preference, a change in environment, or the like, then the tile graphic and/or tile color system 100 may utilize Artificial Intelligence (AI) based algorithms to dynamically update a tile graphic and/or tile color associated with a environment. The AI based algorithms may establish a delineation line of the identified color or graphic. Therefore, the AI based algorithm may evolve the pre-loaded color palettes or graphic associated with an environment by continuously updating the color palettes or graphic associated with each of the environments in the database 114.

Next, at step 310, the tile graphic and/or tile color system 100 may create a master digital library based on the categorized color or graphic of the value tables. All the value tables categorized into environment are then stored in a master digital library.

At step 312, the tile graphic and/or tile color system 100 may store the master digital library in a database, such as the database 114.

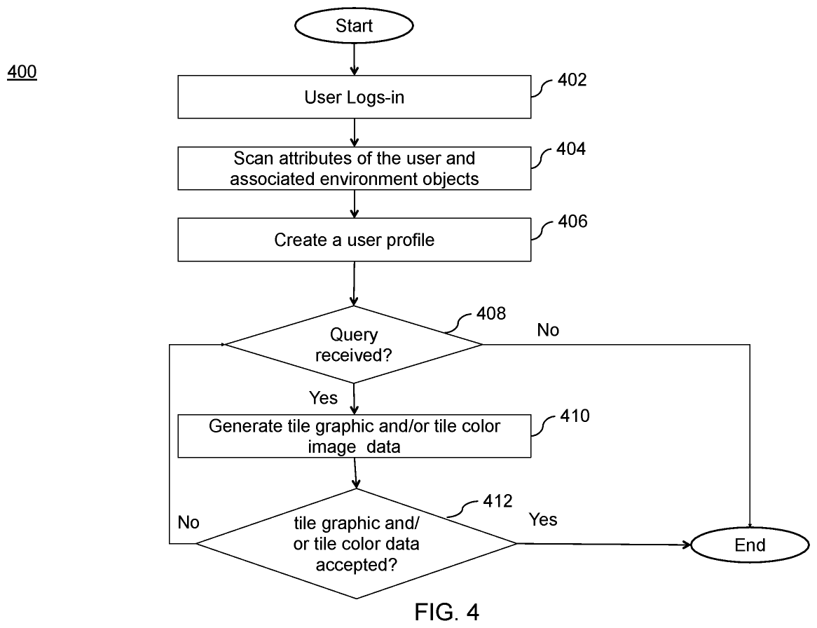

FIG. 4 depicts a flowchart of a method 400 for generating a customized tile graphic and/or tile color to a user, according to another embodiment of the present invention. At step 402, a user logs-in to the tile color or tile graphic application 104 using the user device 102. The user may log-in to the tile color or tile graphic application 104 by using log-in credentials, such as, but not limited to, a sign-in ID and a password, and/or a biometric, for example, a fingerprint, a face recognition, etc. In case, the user is a first time user, then a user interface to sign-up for the tile color or tile graphic application application 104 may be prompted on the user device 102.

At step 404, attributes of the user are input. The attributes may include, but not limited to, the environment as described above. In an embodiment of the present invention, a survey having questionnaire may be performed to collect data from the user about, but not limited to, user preferences and so forth. Based on the input attributes and surveyed data, a user profile is created, at step 406. In an embodiment of the present invention, a unique identification (ID) may be assigned to the user and the data associated with the user may be linked to the unique ID and is then stored in the database, such as the database 114.

At step 408, it is determined that a user query is received or not. In case, it is determined that a user query is received, then the method 400 proceeds towards a step 410. In case, it is determined that a user query is not received, then the method 400 concludes. The user query may include, but not limited to, an environment that belongs to the user, or a color or graphic that may belong to the user, a recommendation, and so forth. The tile graphic and/or tile color system 100 may find a closest match related to the query from the database, such as the database 114.

At the step 410, recommendations are provided to the user based on the query. The recommendation may include, but not limited to, a customized tile graphic and/or tile color, a tangible object stored in the user's inventory that may be used as per the query of the user.

At step 412, it is determined that the generated tile color or tile graphic are accepted by the user. In case, the generated customized tile color or tile graphic are accepted by the user, then the method 400 concludes. In case, the tile color or tile graphic are not accepted by the user, then the method 400 returns to the step 408 and may receive additional query from the user. Based on the additional query, the method 400 continues to provide recommendations to the user.

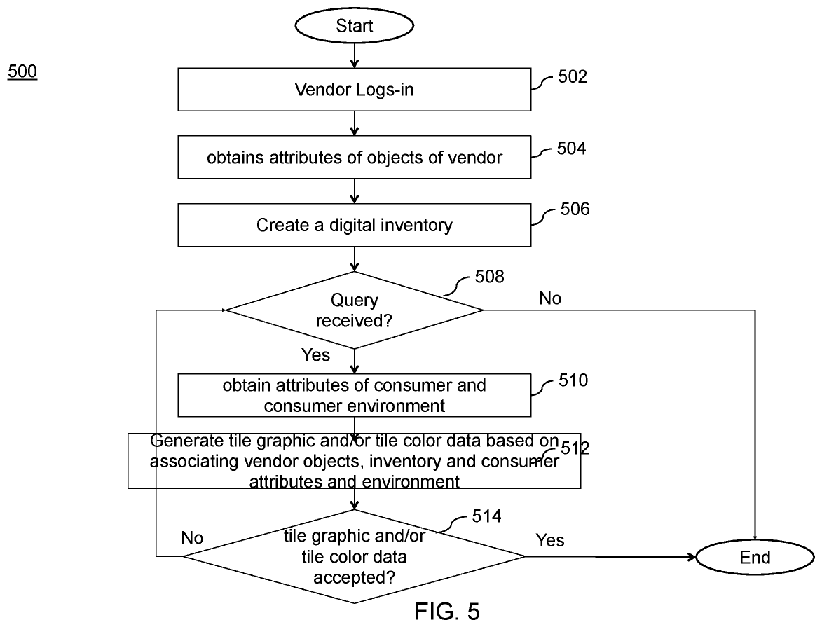

FIG. 5 depicts a flowchart of a method 500 for creating a vendor's digital library of objects and then providing recommendations to a consumer, according to another embodiment of the present invention.

At step 502, a vendor logs-in to the color application 104. The vendor may log-in to the tile color or tile graphic application 104 by using log-in credentials, such as, but not limited to, a sign-in ID and a password, and/or a biometric, for example, a fingerprint, a face recognition, etc.

At step 504, the vendor may input the objects in the inventory. The scanning of the objects may be performed by using the input device 106, or the vendor device 108. While scanning the objects, the input device 106 may input attributes of the objects, which may include, but not limited to, a color or graphic, a type of the object, a pricing of the objects, and so forth. At step 506, a digital inventory for the objects is created.

At step 508, it is determined that a query from a vendor is received or not. In case, a query from the vendor is received then the method 500 proceeds towards a step 510. In case, it is determined that no query is received from the vendor, then the method 500 concludes. In an embodiment of the present invention, the query may include data about an object required by the consumer.

At step 510, attributes of a consumer are input. The attributes of the consumer may include, but not limited to one or more of the environmental attributes discussed.

At step 512, based on the query and input attributes of the consumer, the tile graphic and/or tile color system 100 may generate customized tile color or tile graphic. In an embodiment of the present invention, the tile graphic and/or tile color system 100 may generate to the vendor about objects stored in the inventory of the vendor.

At step 514, it is determined that the recommended objects are accepted by the consumer or not. In case, the generated objects are accepted by the consumer, then the method 500 concludes. In case, the generated objects are not accepted by the consumer, then the method 500 returns to the step 508 and may receive additional query from the vendor. Based on the additional query, the method 500 continues to generate to the vendor.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

The exemplary embodiments of this present invention have been described in relation to tile graphic and/or tile color systems. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

A number of variations and modifications of the present invention can be used. It would be possible to provide for some features of the present invention without providing others.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A tile graphic and/or tile color system for generating at least one customized tile graphic and/or tile color to at least one user, the tile graphic and/or tile color system comprising:
an input module configured to input a plurality of attributes comprising environmental aspects of a user of one or more tangible objects from one of a residential, commercial and retail area, or a combination thereof, associated with the at least one user;
one or more databases configured to store the plurality of input attributes associated with the at least one user;
an analysis module configured to analyze the plurality of attributes by using one or more mathematical algorithms to identify one or more color or graphic for a tile graphic and/or tile color corresponding to each of the plurality of the attributes, wherein the identification of one or more color or graphic comprising:
comparing the color and graphic of the plurality of input attributes with the tile graphic and/or tile color stored in the one or more databases; and
selecting the one or more color and/or graphic from the one or more databases based on the comparison, wherein:
the one or more databases are updated when a new color and/or graphic is identified;
a categorization module configured to determine at least one category for the at least one user based on the identification of the one or more colors and graphic corresponding to each of the plurality of the attributes;
a generation module configured to generate customized tile graphic and/or tile color to the at least one user based on the determined category; and
a display module configured to display the customized tile graphic and/or tile color to the at least one user.

2. The system of claim 1, further comprising a survey module configured to conduct one or more surveys from the at least one user.

3. The system of claim 1, wherein a production module is further configured to receive the customized tile graphic and/or tile color or a combination thereof and produce a the customized tile for printing thereon.

4. The system of claim 1, wherein the generation module is further configured to recommend one or more web addresses for one or more shopping websites.

5. The system of claim 1, further comprising a print module configured to print the at least one recommended customized tile graphic and/or tile color.

6. A computer-implemented method for generating at least one customized tile graphic and/or tile color to at least one user, the method comprising:
inputting a plurality of attributes comprising a plurality of attributes comprising environmental aspects of a user of one or more tangible objects from one of a residential, commercial and retail area, or a combination thereof, associated with the at least one user;
storing the plurality of input attributes associated with the at least one user;
analyzing the plurality of attributes by using one or more mathematical algorithms to identify one or more colors from a tile graphic and/or tile color corresponding to each of the plurality of the attributes, wherein the identification of one or more colors comprising:
comparing the color and graphic of the input plurality of physical attributes with the tile graphic and/or tile color in the one or more databases; and
selecting the one or more color and graphic from the one or more databases based on the comparison, wherein
updating the one or more databases when a new color and graphic is identified;
determining at least one category for the at least one user based on the identification of the one or more color or graphic corresponding to each of the plurality of the attributes;
generating at least one customized tile graphic and/or tile color to the at least one user based on the determined category; and
displaying the customized tile graphic and/or tile color to the at least one user.

7. The method of claim 6, further comprising conducting one or more surveys from the at least one user.

8. The method of claim 6, further comprising generating one or more web addresses for one or more shopping websites.

9. The method of claim 10, further comprising printing the at least one recommended customized tile graphic and/or tile color.
